(19) United States
(12) Patent Application Publication
(10) Pub. No.: US 2008/0221936 A1
(43) Pub. Date: Sep. 11, 2008

(54) AUTOMATED PROPERTY INSURANCE QUOTE SYSTEM

(76) Inventor: Andrew Patterson, Dania Beach, FL (US)

Correspondence Address: MALIN HALEY AND DIMAGGIO, PA, 1936 S ANDREWS AVENUE, FORT LAUDERDALE, FL, 33316, US

(21) Appl. No.: 12/044,390

(22) Filed: Mar. 7, 2008

Related U.S. Application Data
(60) Provisional application No. 60/905,519, filed on Mar. 7, 2007.

(51) Int. Cl. G06Q 40/00

(52) U.S. Cl. 705/4

(57) ABSTRACT

An automated web based application for generating a plurality of insurance quotes for property insurance is disclosed. A data extraction program is used to extract text from an appraisal form in PDF format. This data is used to automatically complete and submit quote request applications to a number of different insurance providers, thus generating a variety of insurance quotes. The application creates a summary of the various insurance quotes, allowing a broker or insurance seeker to quickly and efficiently select a quote. Once a quote is selected, the system automatically creates a binding document using personal information that is either manually input or extracted from a standard loan form, and sends the document to the insurance provider.

### CROSS REFERENCE TO RELATED APPLICATIONS

This application claims the benefit of provisional U.S. Patent Application Ser. No. 60/905,519, filed Mar. 7, 2007.

### STATEMENT REGARDING FEDERALLY SPONSORED RESEARCH OR DEVELOPMENT

N/A

### COPYRIGHT NOTICE

### BACKGROUND OF THE INVENTION

1. Field of the Invention

The present invention relates generally to insurance quotes, and more particularly to an automated insurance quote system and method that extracts data from submitted appraisals and returns insurance quotes through an automated system from multiple insurance providers based upon the extracted data without requiring human data input.

2. Description of Related Art

The process of obtaining insurance quotes usually is carried through by brokers who act on behalf of a customer. In obtaining insurance quotes, brokers must complete application forms that typically require the inputting of generic and repetitive information and then submit these forms to insurance companies who return quotes to the broker. Specifically, for property insurance, brokers need to obtain an appraisal of the property and information describing the location and the risks of the property. This information is typically supplied on a Uniform Residential Appraisal Report (“URAR”), namely Fannie Mae Form 1004 in transactions involving a purchase or re-finance. Once this information is obtained, the brokers then submit various quote requests to the insurance companies, wherein each quote request requires separate forms to be filled out. In situations that do not involve a purchase or re-finance, this information may be obtained without use of the URAR. Based upon the submitted quotes, insurance companies then return accepted quotes, thus creating even larger amounts of forms and information that must be handled.

Due to advances in information and computer technology, a number of different automated systems exist that help brokers in organizing, obtaining, and submitting the large amounts of information and forms required to obtain insurance quotes for customers. In one example, U.S. Pat. No. 4,831,526 issued to Luchs et al. describes a computerized insurance quote system that provides a method for processing and preparing applications for insurance quotes and generating final insurance documents and contracts from input information. The system includes a central computer and database that are both stored on site. The central computer and database are coupled to a plurality of interface and display terminals, which allow appropriate information to be manually entered into the system. The database also includes look up tables that are used to input information that is repeatedly required into documents. One disadvantage is that this system is designed for insurance companies in providing an automated means of calculating insurance quotes. Another disadvantage is that the system is not adapted for use with the Internet and requires that a user be present at a terminal that is directly coupled to the central computer and database in order to access information and obtain a quote.

One of the most critical pieces of information necessary for determining a real estate insurance quote is an appraisal of the property. A number of different real estate computer automated and implemented appraisal methods and systems are described in the prior art. U.S. Pat. No. 5,857,174 issued to Dugan describes a method for determining property value that can be implemented on a computer system to generate appraisal reports. This method uses DUPAACS (Dugan's Pre-Adjusted Appraised Comparable Sales Method for Standardizing Real Property Market Analysis) for creating an appraisal, which scores the property based on a variety of desirability factors. This method can be implanted with a number of other appraisal methods such as Fannie Mae Forms 2055, 2065, and 2075.

U.S. Pat. No. 6,842,738 issued to Bradley et al. also describes a method and system for determining property value based upon data stored in a database. The system allows users to access estimated appraisals before the appraisal is processed and the property value is determined. This system obtains data from loan agencies, such as Freddie Mac and Fannie Mae, on the sales records of real estate sales in the county where the property is located. This information is used in providing an estimate of the property value, through a process that is automated on a computer system.

More convenient automated systems that utilize networks to exchange data contained in applications and forms have been adapted for use by mortgage brokers and lenders. U.S. Pub. No. 200310233316 A1 issued to Hu et al. and U.S. Pub. No. 2005/0049961 A1 issued to Hansen both describe web based systems for submitting and processing loan applications. These systems provide a loan broker with a program that is executable on a computer, through which applications can be completed and submitted to lenders and loan underwriters. The applications can be outputted in a variety of formats including Freddie Mac or Fannie Mae formats. The use of a web based application generation program automatically inputs generic information into loan forms, thus saving the broker time. The web based program provides an efficient means of sending data by eliminating the need for large volumes of paper.

Automated web based systems for both real estate appraisal and mortgage brokering and underwriting is widely discussed in the prior art. These automated systems have not been adapted for use by insurance agents, brokers, and companies. Faced with similar challenges as the process of obtaining loans, receiving insurance quotes requires that a large numbers of applications be filled out that require the input of a generic repeated information. There thus exists a need for an automated system that inputs information into multiple insurance quote applications for the purpose of obtaining a number of quotes for evaluation, thus saving insurance brokers vast amounts of time. Furthermore, a need also exists for a web based system that allows insurance brokers to access and input information required for completing real estate insurance applications, such as property appraisals. Finally there exists a need for a system that allows insurance broker to submit applications electronically over a network, thus saving time and money in preparing, printing, and sending large numbers of applications for insurance quotes to the insurance companies.

### BRIEF SUMMARY OF THE INVENTION

The present invention overcomes the limitations and disadvantages in the art by providing an automated web based system and method for submitting insurance quote requests to one or more insurance companies for the purpose of obtaining insurance quotations. The method includes the steps of the broker first creating an account in the system. Once an account is created and the broker is provided with a username/password, the website can be accessed by the broker to submit insurance quotes to insurance companies.

The process of submitting an insurance quote for a purchase or re-finance involves the broker first obtaining an appraisal reported on a Uniform Residential Appraisal Report or URAR. The URAR is obtained in a Portable Document Format (“PDF”) file that is either sent though an e-mail, fax, or uploaded to the database through a web based application. Once the URAR appraisal for a specific property is submitted and stored in the database as a PDF file, data that is necessary for submitting insurance quotes to insurance companies is extracted from the URAR PDF using plain text PDF extraction technology. The data that is extracted from the URAR file includes information relating to the location of the property, the owner of the property, the potential hazard areas that the property lies within, improvements made to the property, features of the property used for a sales comparison approach method of appraisal, and a specifications of the property used for a cost approach method of appraisal. Once this information is extracted from the URAR file it is stored on the database with the individual broker information.

After the information is extracted from the URAR-PDF file and stored on the database, a request may be made to an appropriate state windstorm underwriting group, such as FWUA (Florida Windstorm Underwriting Association), to determine whether or not the property lies within a windpool region or other special zone. Once it is determined whether or not the property lies within a windpool zone, a number of different quote request forms are completed based upon the information obtained from the appraisal reports and submitted to various insurance companies. The type of quote requests that are compiled depend on whether or not the real estate lies within a windpool zone. Within the windpool and non-windpool zone regions, the property insurance quotes vary in the types of deductibles, the amount of each deductible, and the amount of coverage provided by each quote.

After the quotes request forms are compiled and created using the PDF extraction technique, they are then electronically submitted, through the Internet, to a variety of insurance companies or providers (such as agents) by automatically electronically populating each insurance company's on-line insurance quote request form. As used herein, the term “insurance provider” shall broadly be defined as including insurance companies, insurance agents and brokers, or any entity capable of providing an insurance quotation. These forms are submitted only if the underwriting guidelines for the individual insurance company are met. The returned approved quote information from the submitted forms is then stored in the database and linked to the specific appraisal for a given property. Once the quote information is returned for a given request and the information is stored on the database, a quote summary form is created. The quote summary form lists the various quotes returned by the insurers for a given property appraisal. This form is stored on the database as a PDF file that is linked to the specific appraisal and then sent in an email to the broker that submitted the request. The quote summary response PDF file is also accessible through any interface that supports the web based application. The web based application includes a webpage that contains links to every quote summary PDF file that is stored on the database, for a submitted property appraisal. This webpage that is supported by the web based application is accessible to the broker though the use of the unique username/password that is provided during registration. If the property lies outside of windpool region, a desired returned quote can be bound through the web based application. By selecting a quote to bind, the broker must enter specific information of the applicant, after which the bind information is converted into an individual insurance company's application form and sent back to the company as a PDF file attached to an email.

As should be apparent, the present invention should not be limited to property insurance and is suitable for use in applications wherein standardized data is required for any insurance quotation.

It is an object of the present invention to provide an automated web based system that retrieves real-time insurance quotes from multiple insurance providers without the need for manual data entry.

It is another object of the present invention to provide an automated web based system for retrieving real estate quotes from multiple insurance providers that extracts data from an appraisal form in a PDF file.

It is yet another object of the invention to provide an automated web based system for retrieving real estate quotes from multiple insurance providers that extracts data from a PDF file appraisal form that is submitted through email, upload, or fax.

It is still another object of the invention to provide an automated web based system for retrieving real estate quotes from multiple insurance providers that extracts data from a PDF file appraisal form that is submitted by uploading the file through a website.

It is furthermore an object of the present invention to provide an automated web based system that retrieves real estate quotes from multiple insurance providers and creates a summary of the quotes that is accessible through a website and saved on a database.

It is another object of the present invention to provide an automated web based system that retrieves and present a summary of multiple real estate quotes for a give property appraisal that allows a user to select a desired quote and creates a bind form that is sent to the appropriate insurance provider.

### BRIEF DESCRIPTION OF DRAWINGS

FIG. 1 shows a flow diagram detailing the process steps in accessing the web based insurance agent/broker application;

FIG. 2 shows a flow diagram detailing the process steps for a broker submitting an appraisal;

FIG. 3 shows a flow diagram of the process steps in gathering information required for submission to insurance providers to generate insurance quotes;

FIG. 4 shows a flow diagram of the process steps in retrieving quotes from multiple insurance providers and compiling a quote summary;

FIG. 5 shows a flow diagram of the process steps involved in selecting and creating a bind form for a quote;

FIG. 6 shows a screen shot of the main webpage;

FIG. 7 shows a screenshot of the submit quote request webpage.

FIG. 8 shows a screenshot of the uniform appraisal report data collection webpage;

FIG. 9 shows a sample appraisal report from which data is extracted from and used to create a variety of quote request forms;

FIG. 10 shows a screenshot of an insurance provider form that is automatically completed by the web based program and is submitted for receiving quotes;

FIG. 11 shows a screenshot of an insurance quotation summary; and

FIG. 12 shows a screenshot of required information for binding.

### DETAILED DESCRIPTION OF THE INVENTION

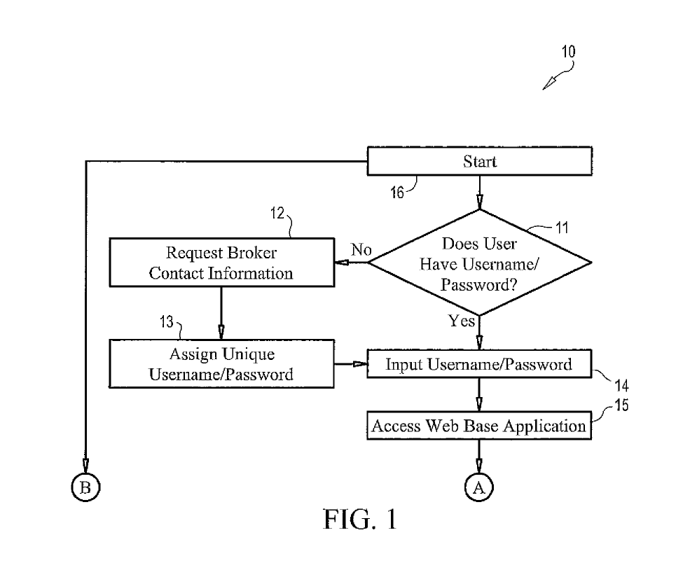

Referring now to the drawings, specifically FIG. 1 shows a flow diagram illustrating the process steps required for a user to access the web based real estate insurance quote retrieval system in accordance with the present invention. Upon starting the web based system 10, which is preferably accessed through an Internet website, the user is prompted to enter a username and a password 11. If the user does not have a login username and password the contact information of the broker or user is requested 12. After the contact information is input into the system, a unique login username and password are assigned 13 to the user. Once the user has a username and a password, they are input 14 allowing complete access to the web based application 15, thus completing the process of logging in to the web based application 10.

FIG. 6 shows an image of the main webpage 100 that is presented once a user logs into the web based application 10. The main web page includes links to submitting a quote request 101, reviewing a submitted quote request 102, creating a quote request 103, the general information of the user/broker 104, creating a manual quote letter 105, and logging off of the to web based application.

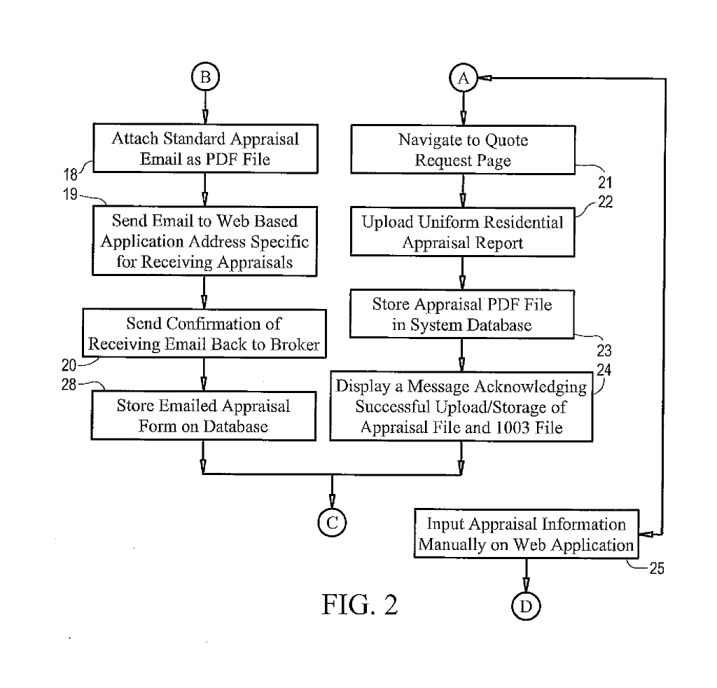

FIG. 2 is a flow diagram illustrating the process steps in submitting an appraisal is shown. A standard appraisal form can be but is not limited to the common Fannie Mae 1004 form. The appraisal form information can either be emailed 18 or submitted by logging into the web based application 17 and uploading the form to the system. If the user chooses to email the appraisal 18, then the URAR form is attached as a PDF file and sent to an address provided by the web based application for receiving URAR appraisal forms 19. The Portable Document Format (PDF) is the file format created by Adobe Systems in 1993 for document exchange. PDF is a fixed-layout format used for representing two-dimensional documents in a manner independent of the application software, hardware, and operating system. Each PDF file encapsulates a complete description of a 2-D document (and, with Acrobat 3-D, embedded 3-D documents) that includes the text, fonts, images, and 2-D vector graphics that compose the document.

The user can also attach a standard Uniform Residential Loan Application form (Fannie Mae Form 1003) or suitable equivalent data form, to provide information for creating a binding form once a quote has been selected. Upon receipt of the appraisal form through email, a confirmation email is sent back to the user signaling receipt of the appraisal 20 and the appraisal is stored on the system database 28. The appraisal form is stored on the system database 28 with a unique tag that identifies the user/broker responsible for uploading the specific appraisal.

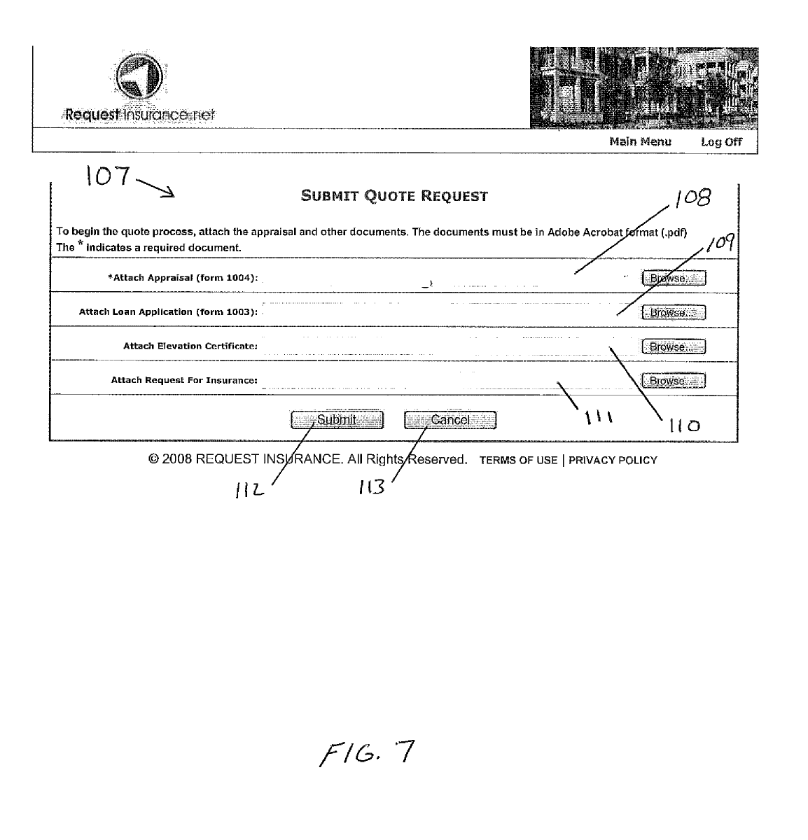

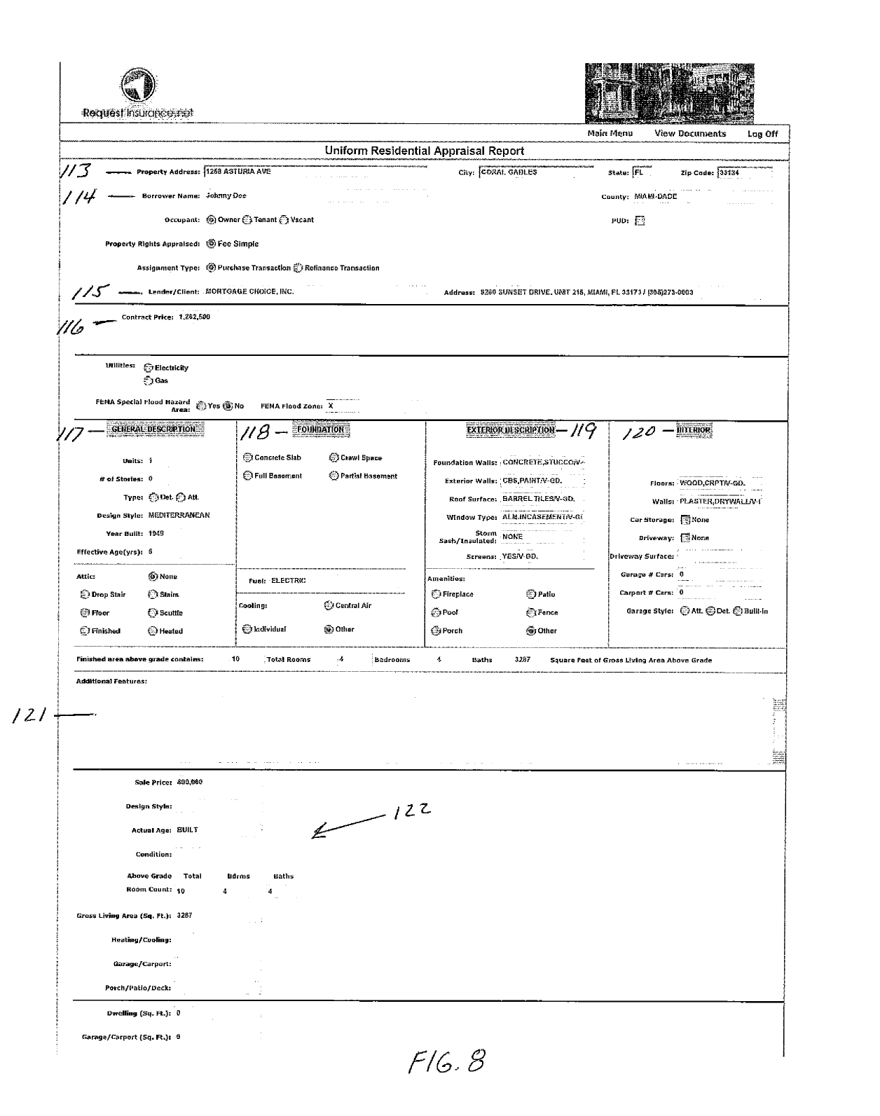

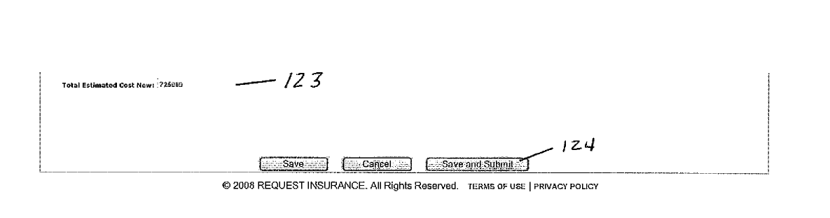

If the user chooses to submit the appraisal information by logging into the web based application 17, then the appraisal form can be either directly uploaded in PDF format. In the alternative, the information from the appraisal can be manually input through the web based application 25. To manually input the appraisal info through the web based application 25, the user activates a create a quote request link 103 from the main page 100 as illustrated in FIG. 6. The user then manually enters information, such as the value of the property, which is standard to appraisal forms and is required for obtaining an insurance quote. To directly upload the appraisal form, the user navigates to the quote request page 21 by activating the submit a quote request link 101. FIG. 7 shows an image of the submit quote request website which includes an upload link for attaching an appraisal file 108, an upload link for attaching a loan application 109 which can be but is not limited to a Fannie Mae form 1003, an upload link for attaching an elevation certificate 110, and upload link for attaching a request for insurance 111. The submit quote request page also includes a buttons 112 and 113 for submitting the attached files or canceling the submission of attached files.

A standard appraisal form is uploaded 22 by attaching the appraisal form as a PDF file and activating the submit link 112. A standard loan form can also be uploaded with the standard appraisal form 22 to provide information for creating a binding form. Once the appraisal form is uploaded 22, it is stored as a PDF file on the system database 23 with a unique marker that identifies the broker responsible for uploading the appraisal. Upon successful uploading 22 and storage 23 of the appraisal PDF file, a confirmation message is displayed to the user 24.

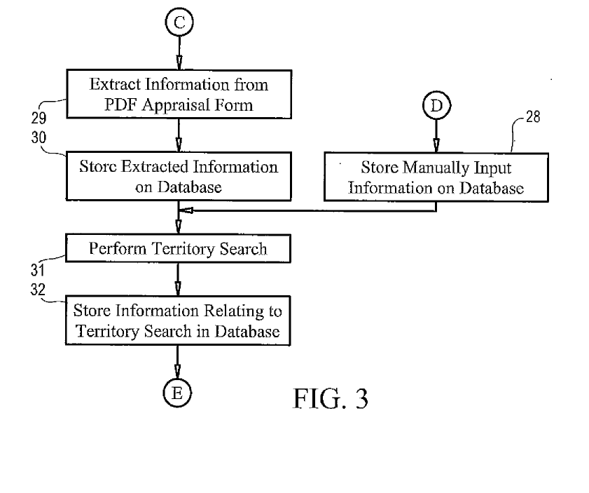

A significant aspect of the present invention involves automating the data entry by obtaining data needed to obtain an insurance quote from standardized URAR appraisal forms. More particularly, FIG. 3 shows a flow diagram illustrating the process steps for automatically obtaining data from the URAR appraisal form by PDF extraction, which extracted data is automatically input into the system through the processes described in FIG. 2. Specifically, if the information found in an appraisal is manually input through the web based application by a user 25, then this information is subsequently stored on the system database 28 with a tag identifying the broker responsible for inputting the appraisal information manually. If the appraisal file is received through email or uploaded through the website, and subsequently stored in the system data base as a PDF file 27. Once the data is stored in PDF format, the system extracts relevant data as plain text from the appraisal PDF file 29 through a PDF extractor program that uses a PDF manipulation library. The extracted plain text is subsequently stored on the database 30. In an alternate embodiment of the present invention, optical character recognition processing is used to extract text from the PDF file for use in completing insurance quote request forms.

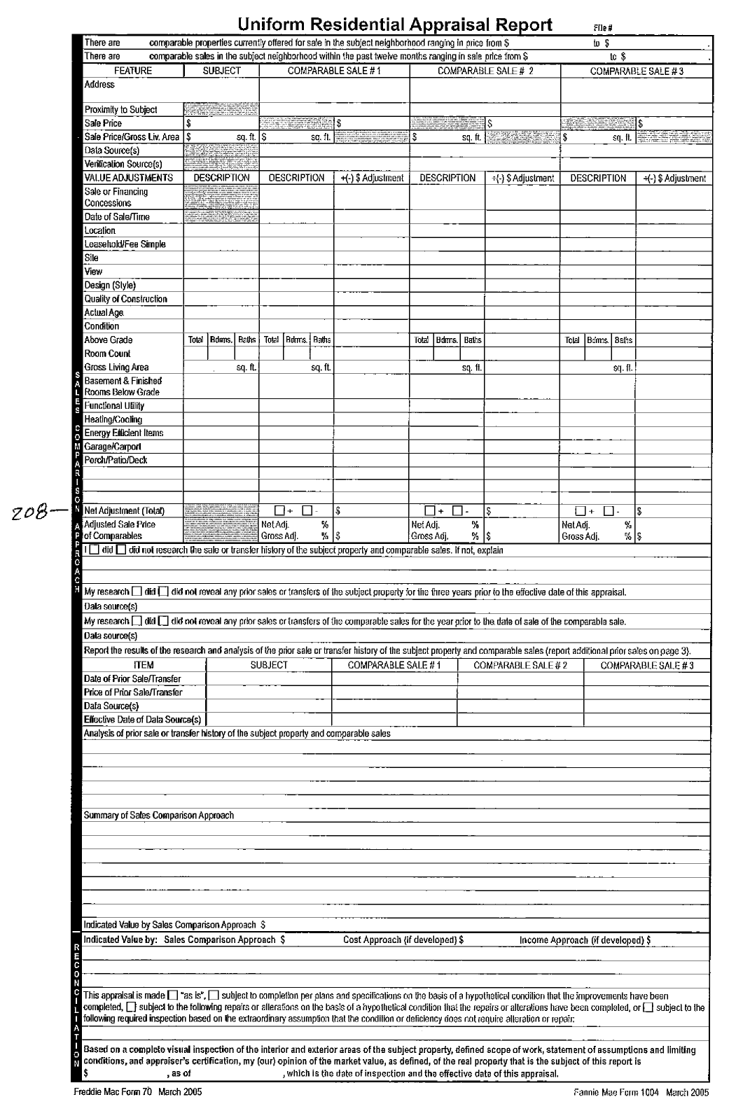

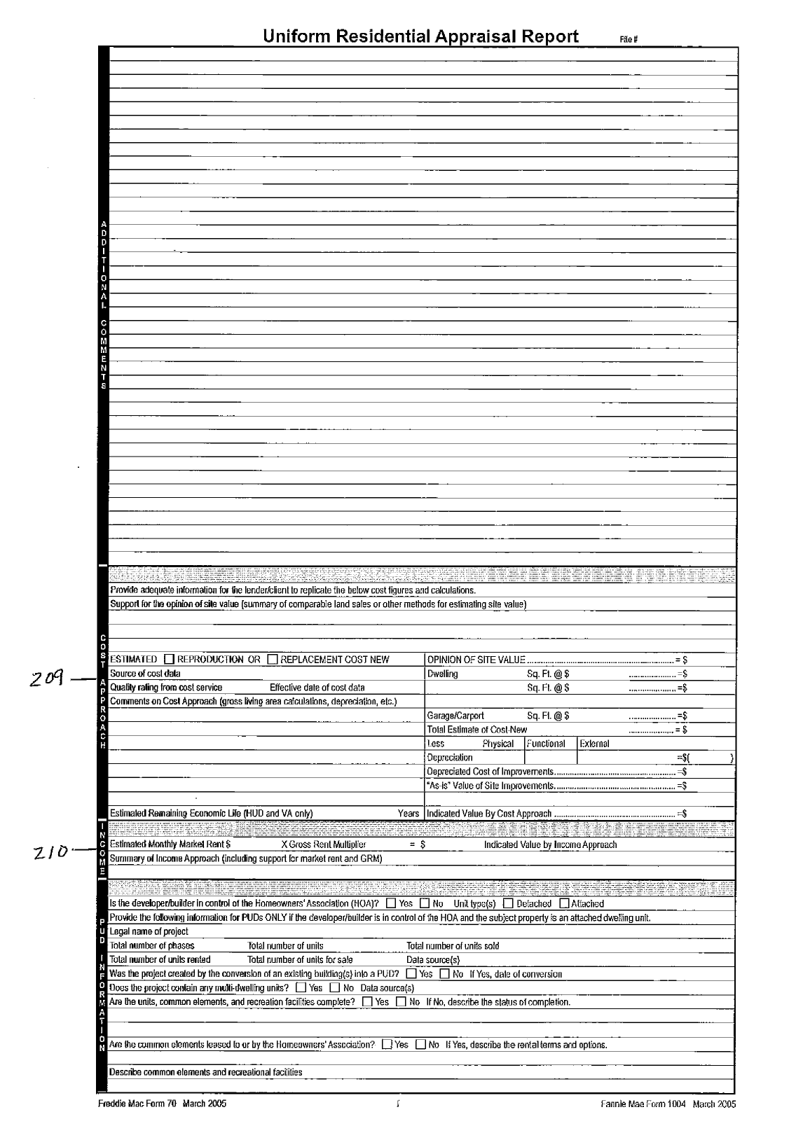

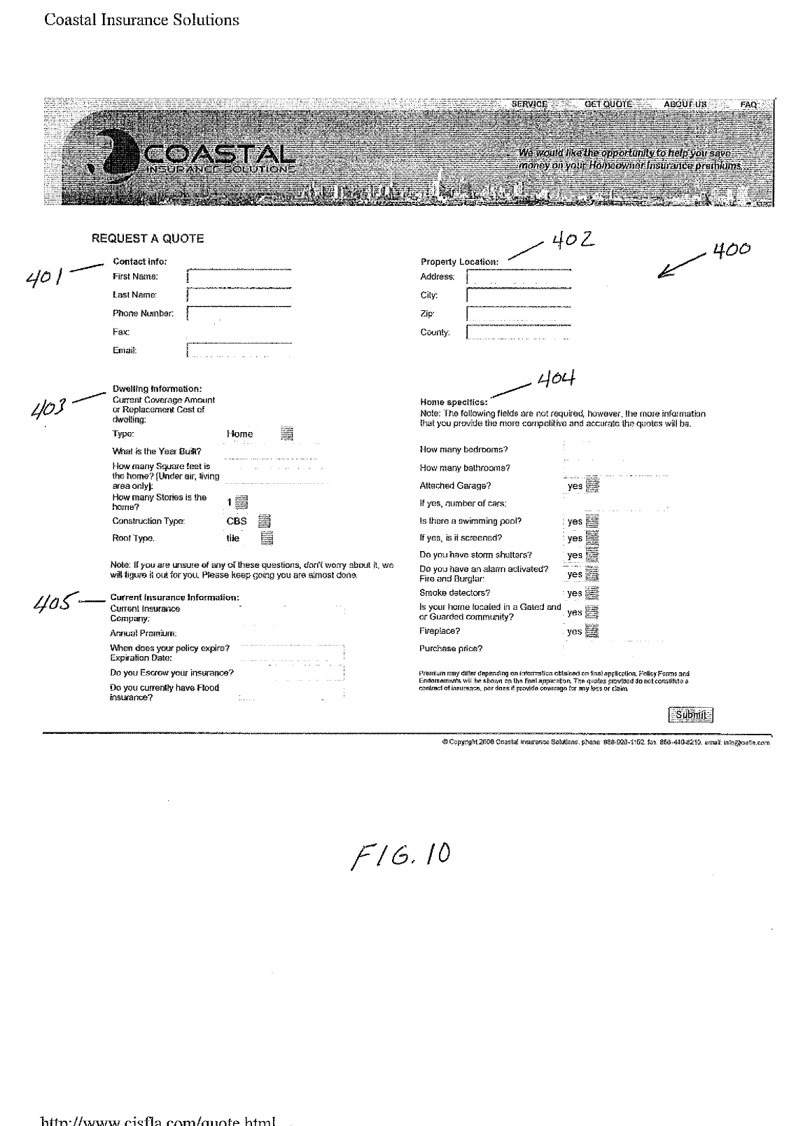

FIG. 9 shows a sample URAR, referenced as 200, which form may be either uploaded to the database or received through email. The standard appraisal report form 200 contains standard information that is used to populate the fields of the uniform residential appraisal report data collection webpage. This information includes the property address 201, the borrower 202, and the lender 203. The appraisal report also includes a contract section 204 which includes information relating to the contract or loan information related to the property. A neighborhood section 205 describes the characteristics of the neighborhood that the property is located in. A site data section 206 describes specific information of the site that the property lies on. An improvements section 207 lists improvements made to the property thus increasing the overall value. A sales comparison approach section includes specification of the property, such as the total number of bedrooms, and is one method of appraising the property. An additional comments section 214 contains information describing additional features of the property that are useful in determining its overall value. A cost approach to value section 209 contains the information that is used to calculate the value of the property based upon the cost approach method, which is ultimately used as the final appraisal value that is submitted to insurance providers. Finally, the appraisal report includes an income section 210 which contains information used in calculating the value of the house through the income approach method. All of this information is extracted from the form through a PDF extractor program and used to complete the information fields in the uniform residential appraisal report data collection webpage.

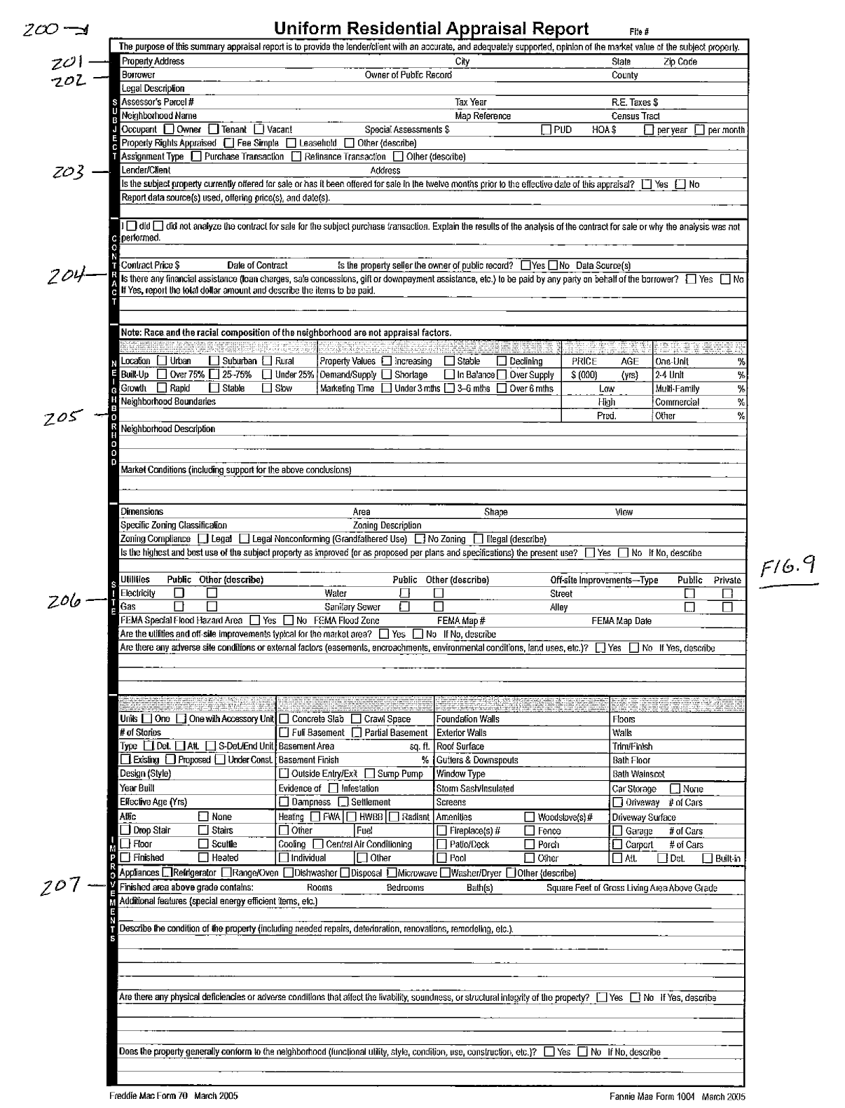

FIG. 8 shows a screenshot of the uniform residential appraisal report data collection webpage that is completed in order to obtain a quote request. The residential appraisal report is completed with the information that may be obtained through either manual input or data extraction from the appraisal report. The uniform appraisal report consists of a number of fields that must be populated including the property address 113, the borrower name 114, the lender/client 115, and the contract price of the lender 116. The appraisal report also includes fields relating to a general description of the property 117, such as the design style and year that the property was built, the foundation of the property 118, the exterior description of the property 119, and the interior description of the property 120. A field is provided for including additional features of the property 121 that add to the overall appraised value. A series of fields are used to convey general information for the property 122, such as the sale price, the design style, the condition of the property, the size of the property, and the features of the property such as the total number of bedrooms and total number of bathrooms. Finally, the appraisal report includes a total estimated cost data space 123 that is used to input the value of the property based on a cost approach method of appraisal. The uniform residential appraisal form includes a save/submit link 124 that submits the form for processing in generating quotes, and saves the form to the database.

Regardless of whether or not the text information from the appraisal is stored on the database following manual input 28, PDF extraction 30, through a manipulation library, after the standard information from the appraisal is stored as text on the database, a territory search is performed 31 based upon the location of the property as illustrated in FIG. 3. The location of the property is obtained from the appraisal information. The territory search 31 involves determining whether or not the property lies within a windpool region. In order to determine if the property lies within a windpool region, the state windstorm underwriting group for the particular property is referenced. For example, in Florida, FWUA provides a list of addresses and locations that lie within the wind pool region. The windpool region is defined as the areas that are more prone to damage during hurricanes. After a territory search is performed 31, the subsequent obtained information is stored on the database 32 along with the plain text appraisal information, thus completing the process of gathering the necessary information required for obtaining quotes from insurance providers.

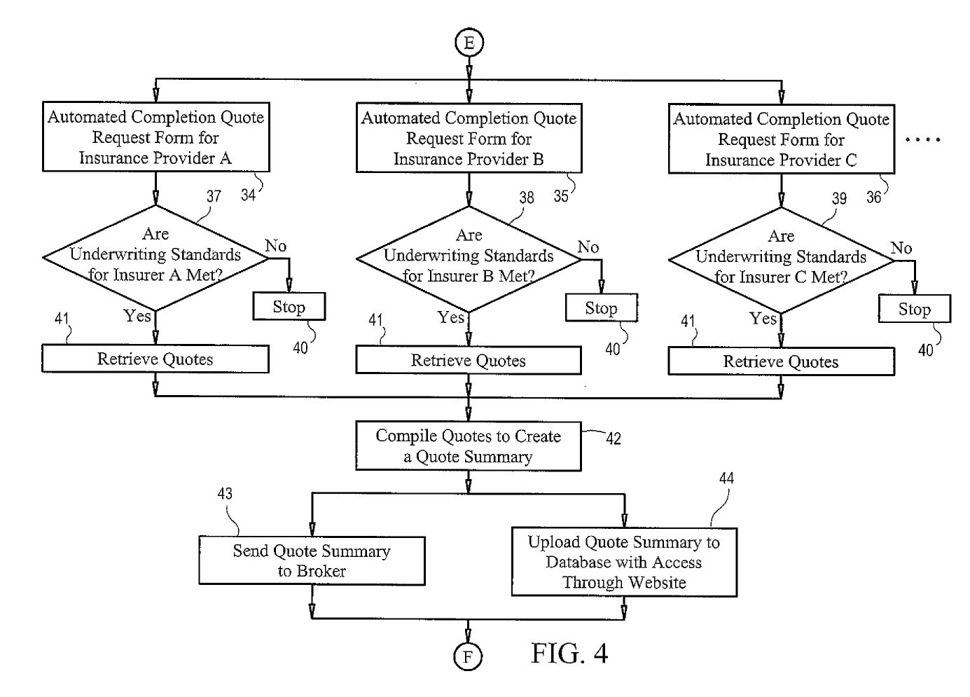

FIG. 4 shows a flow diagram illustrating the process steps in obtaining and summarizing multiple quotes from various insurance providers. Specifically, after the necessary information is obtained and extracted, the web based program automatically completes quote request forms for multiple insurance providers 34, 35, and 36 through a process that can be but is not limited to screen scraping. For each insurance provider, the information required by the provider and associated information format is first ascertained such that all of the required input fields and optional inputs and/or defaults are determined. This allows for the processing of extracted data such that the extracted data may be automatically input to each of the insurer's data input forms by auto-population of data thereby completely eliminating the need for manual data entry or data gathering. The quote request forms can also be accessed through more direct and efficient methods such as web services or other direct application program interfaces.

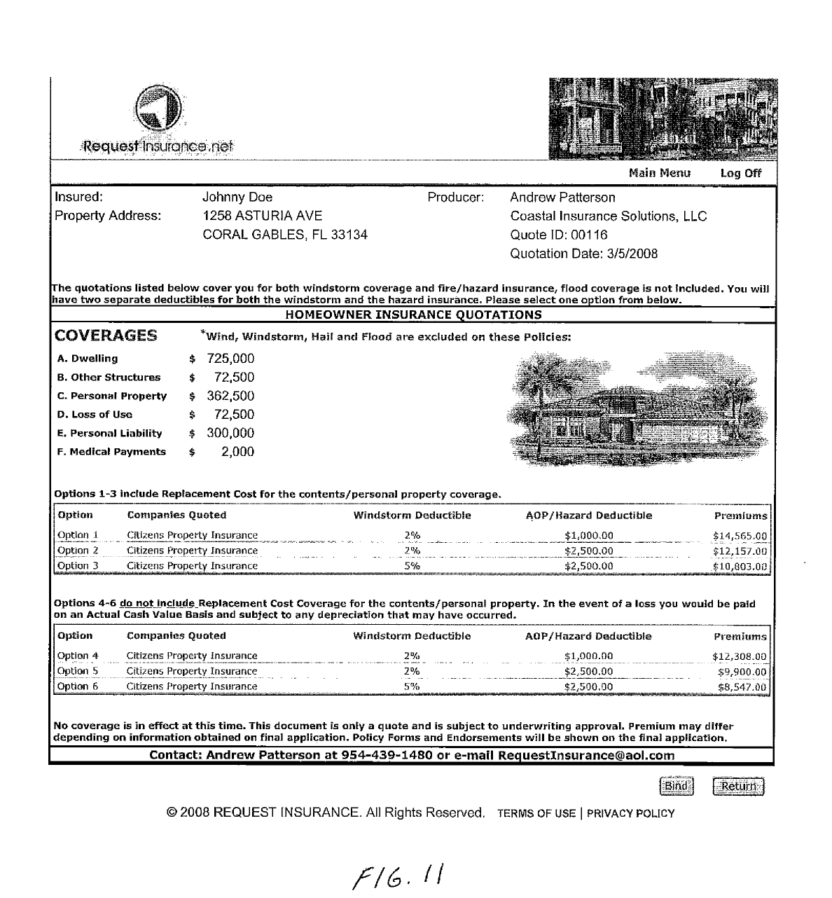

FIG. 11 shows a sample screenshot of a sample quote request form for an insurance provider containing information fields that must be populated with data obtained from the URAR preferably via PDF extraction, or by other means. The quote request form 400 consists of contact information 401 of the person requesting the quote, such as the broker, and the location of the property 402. The quote request form 400 also includes information on the dwelling 403, such as the type of property and when the property was built. A space for more specifics of the property 404 such as the number of bedrooms and bathrooms and the purchase price of the property is provided. Finally, the quote request page includes a section detailing the current insurance information 405 for the property.

The web based application checks that the data obtained from the appraisal forms and territory searches that is used to fill the quote request form, meets the underwriting standards for each individual insurance provider 37. If the information from the quote request form does not meet the underwriting standards of a specific insurance provider, then the quote request forms are not submitted 40. If the information in the quote request forms does meet the underwriting standards of the individual insurance provider, then the form is submitted and the quotes are retrieved 41 through the Internet in a completely automated process.

Once the quotes are retrieved 41, they are subsequently compiled and stored in a quote summary 42. The format of the quote summary 42 depends on whether or not the property lies within a windpool zone. If the property is within a windpool region, then quotes representing two separate polices are presented. The first policy covers only damage caused by winds, while the second policy covers all potential hazards except for wind. If the property is not within a windpool region, then the quotes represent a combination policy that includes both wind and multi peril damage coverage. Once the quote summary is created, a PDF file version of the quote summary is sent to the broker associated with submitting the appraisal through email 43, and the quote summary is uploaded to the database and made accessible through the website of the application 44.

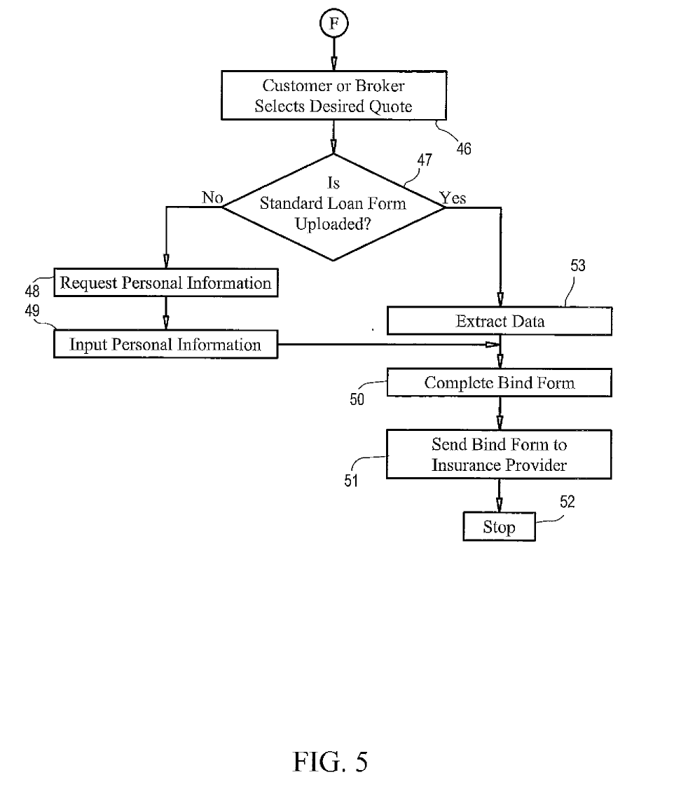

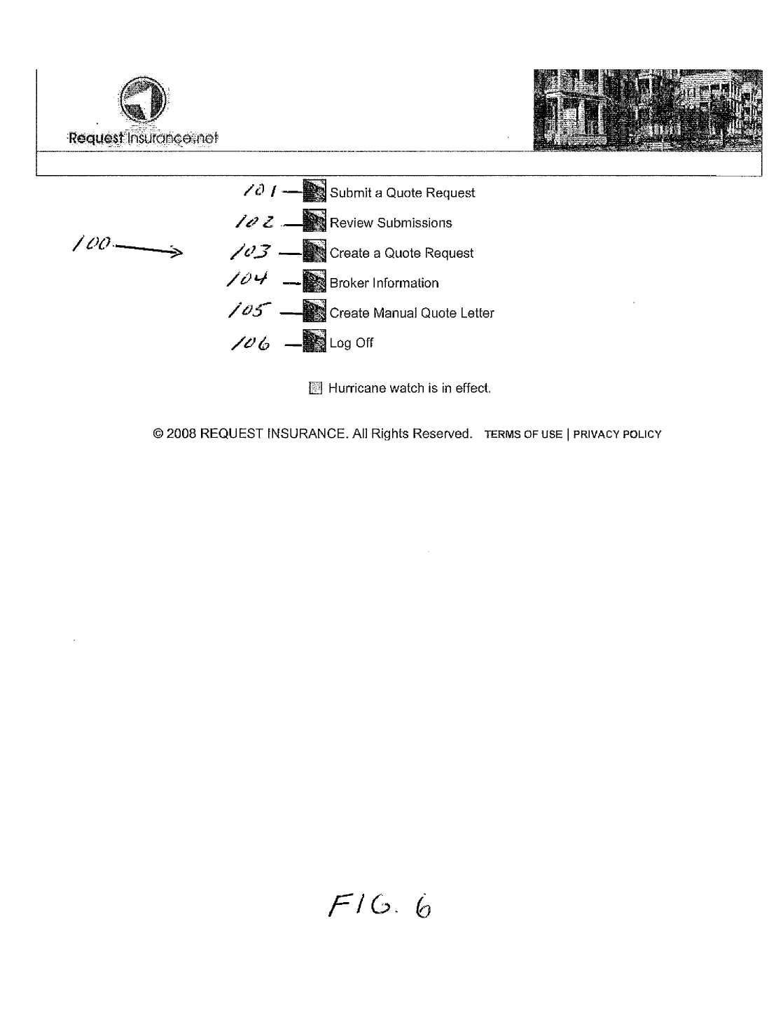

FIG. 5 shows a flow diagram illustrating the final process steps in selecting a quote and creating a bind form. Once the process of creating and displaying the quote summary is completed 45, the broker or customer selects a desired quote 46 by activating a bind link. Once the desired quote is selected 46, it is determined whether or not a standard loan form, such as a Uniform Residential Loan Application (Fannie Mae form 1003) (URLA), has been uploaded to the database 47. If the standard loan form has not been updated, then the application requests standard personal information 48 that can be obtained using a standard loan form, such as a customers social security number. The URLA consists of information relating to the borrower who in turn is the owner of the property looking for insurance. This information includes the borrower's name, the social security number of the borrower, the current address of the borrower, and the mailing address of the borrower.

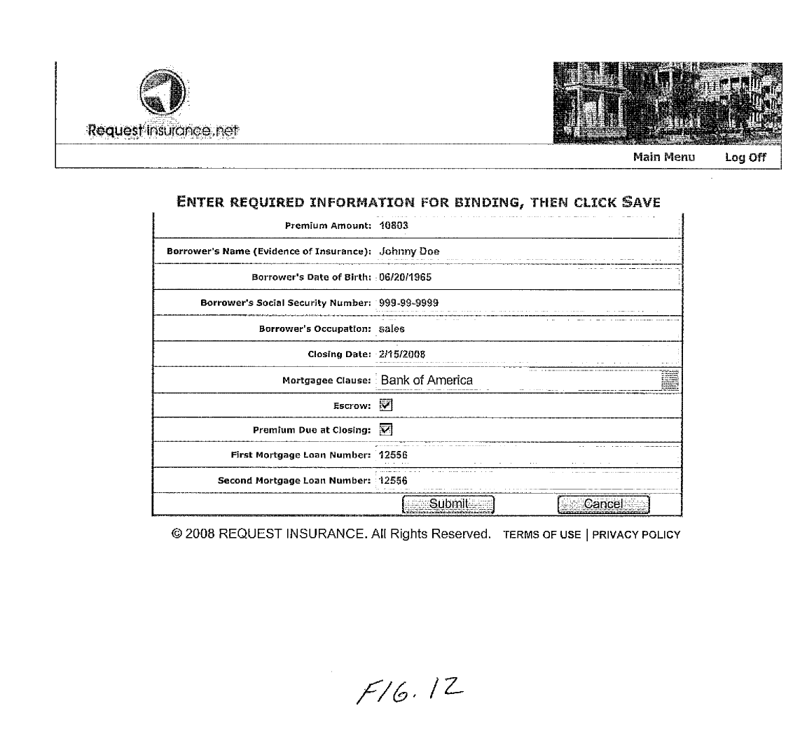

Once the standard personal information is input 49 through the website and stored on the database, the information is used to complete a bind form 50 for the desired quote 50. If a standard loan form has been uploaded to the database, the data is extracted from the loan form 53 and then used to complete the fields of a bind form 50. The bind form consists of standard information on the applicant and resembles the generic application forms for an individual insurance provider. Once the bind form 50 is completed, it is emailed as a PDF file to the insurance provider 51, so that the form can be printed out and signed. FIG. 11 illustrates an output screen presenting six property insurance options. FIG. 12 is a screen shot illustrating the steps taken to bind an insurance quote selected from FIG. 11.

In another embodiment of the present invention, while performing the territory search to determine whether or not the property lies within a windpool region, a flood zone search is performed. Based upon the data describing the location of the property with respect to a flood zone that is returned from the flood zone search, a quote request form for flood insurance is completed and submitted to a variety of insurance providers. Using the same previously described method, a quote summary form is created for the flood insurance quotes, and the broker or customer can select the desired flood insurance quote.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. An automated method of obtaining insurance quotations for real property from one or more insurance providers over a global computer network without requiring manual data input, said method including the steps of:
(a) obtaining an appraisal report for a parcel of real property;
(b) converting said appraisal report into a portable document format (PDF) file;
(c) storing said PDI file in a computer database;
(d) extracting data from said PDF file using a PDF data extractor;
(e) requesting an insurance policy quotation from at least one insurance provider by establishing electronic communication with said at least one insurance provider over a global computer network and automatically electronically transmitting extracted data to said at least one insurance provider; and
(f) electronically receiving at least one insurance policy quotation from said at least one insurance company provider.

2. A method of obtaining insurance quotations according to claim 1, further including the steps of:
(g) compiling a plurality of insurance policy quotations; and
(h) generating a quotation summary report.

3. A method of obtaining insurance quotations according to claim 2, further including the steps of:
(i) means for selecting one of said plurality of insurance quotations for binding; and
(j) means for binding a selected one of said plurality of insurance quotations.

4. An automated method of obtaining insurance quotations for real property from one or more insurance providers over a global computer network without requiring manual data input, said method including the steps of:
(a) obtaining an appraisal report for a parcel of real property, said report including a uniform residential appraisal report form in a portable document format (PDF) file;
(b) storing said PDF file in a computer database;
(e) extracting data from said PDF file using a PDF data extractor;
(d) determining data input requirements for obtaining a quotation over a global computer network for at least one insurance provider;
(e) requesting an insurance policy quotation from at least one insurance provider by establishing electronic communication with said at least one insurance provider over a global computer network and automatically electronically transmitting extracted data to said at least one insurance provider in accordance with the data input requirement of said at least one insurance provider;
(f) electronically receiving at least one insurance policy quotation from said at least one insurance company provider by electronic communication over a global computer network;
(g) compiling a plurality of insurance policy quotations; and
(h) generating a quotation summary report including said plurality of insurance policy quotations.

5. A method of obtaining insurance quotations according to claim 4, further including the steps of:
(i) means for selecting one of said plurality of insurance quotations for binding; and
(j) means for binding a selected one of said plurality of insurance quotations.

6. A method of obtaining insurance quotations according to claim 5, wherein said means for binding a selected one of said plurality of insurance quotations includes obtaining information in the form of a uniform residential loan application in PDF format, extracting selected information from said uniform residential loan application, and electronically transmitting said extracted selected information to the insurance provider over a global computer network.
